(19) United States
(12) Patent Application Publication
(10) Pub. No.: US 2016/0236725 A1
(43) Pub. Date: Aug. 18, 2016

(54) VEHICLE FLOW-REGULATING STRUCTURE

(71) Applicant: TOYOTA JIDOSHA KABUSHIKI KAISHA, Toyota-shi (JP)

(72) Inventor: Yasuhiro SHIRAI, Toyota-shi (JP)

(73) Assignee: TOYOTA JIDOSHA KABUSHIKI KAISHA, Toyota-shi (JP)

(21) Appl. No.: 14/996,660

(22) Filed: Jan. 15, 2016

(30) Foreign Application Priority Data
Feb. 16, 2015 (JP) 2015-028057

(51) Int. Cl. B62D 35/00

(52) U.S. Cl. CPC B62D 35/00

(57) ABSTRACT

A vehicle flow-regulating structure includes a surrounding information detection section that is provided on a roof of a vehicle and that detects surrounding information of the vehicle, and a roof visor (a flow-regulating means) that is provided on the roof and that regulates airflow at the surrounding information detection section while the vehicle is travelling.

### CROSS-REFERENCE TO RELATED APPLICATION

This application claims priority under 35 USC 119 from Japanese Patent Application No. 2015-28057 filed on Feb. 16, 2015, the disclosure of which is incorporated by reference herein.

### BACKGROUND

1. Technical Field

The present invention relates to a vehicle flow-regulating structure.

2. Description of the Related Art

Japanese Patent Application Laid-Open (JP-A) No. 2005-291808 describes a structure in which a sensor such as a camera or radar is mounted on a roof of an autonomous vehicle.

### SUMMARY OF THE INVENTION

However, the above-described conventional example does not particularly take airflow or noise and vibration (NV) performance in a vicinity of the sensor (surrounding information detection section) on the roof while the vehicle is travelling into consideration.

An object of an exemplary embodiment of the present invention is to improve aerodynamic performance and NV performance in vehicles including a surrounding information detection section on the roof.

### Solution to Problem

A vehicle flow-regulating structure according to a first aspect of the present invention includes a surrounding information detection section that is provided on a roof of a vehicle and that detects surrounding information of the vehicle, and a flow-regulating means that is provided on the roof and that regulates airflow at the surrounding information detection section while the vehicle is travelling.

In this vehicle flow-regulating structure, the airflow at the surrounding information detection section provided on the roof while the vehicle is travelling is regulated by the flow regulating means provided on the roof. The air resistance and noise while the vehicle is travelling is thereby reduced.

A second aspect is the vehicle flow-regulating structure according to the first aspect, wherein the flow-regulating means is provided at a vehicle front side of the surrounding information detection section, or in a vicinity of the vehicle front side of the surrounding information detection section, and is a roof visor that extends diagonally upward toward a vehicle rear side.

In this vehicle flow-regulating structure, the roof visor that extends diagonally upward toward the vehicle rear side is provided at the vehicle front side of the surrounding information detection section, or in the vicinity of the vehicle front side of the surrounding information detection section, such that airflow is guided to the vehicle upper side of the surrounding information detection section while the vehicle is travelling. The airflow is accordingly less liable to hit the surrounding information detection section.

A third aspect is the vehicle flow-regulating structure according to the second aspect, wherein at least one of a length of the roof visor, or an angle of the roof visor with respect to a horizontal direction, in a vehicle side view is variable.

In this vehicle flow-regulating structure, changing at least one of the length of the roof visor, or the angle of the roof visor with respect to the horizontal direction, in vehicle side view enables the airflow to be controlled according to the configuration and placement of the surrounding information detection section.

A fourth aspect is the vehicle flow-regulating structure according to the first aspect, wherein at least part of the surrounding information detection section is incorporated in the flow-regulating means.

In this vehicle flow-regulating structure, at least part of the surrounding information detection section is incorporated in the flow-regulating means, such that less of the surrounding information detection section is exposed on the roof.

A fifth aspect is the vehicle flow-regulating structure according to any one of the first aspect to the fourth aspect, wherein a wire harness extending from the surrounding information detection section is passed through a wire harness passage section provided at the roof.

In this vehicle flow-regulating structure, the wire harness extending from the surrounding information detection section is passed through the wire harness passage section, such that the wire harness is suppressed from being exposed on the roof.

### Advantageous Effects of Invention

The vehicle flow-regulating structure according to the first aspect of the present invention obtains an excellent advantageous effect of enabling the aerodynamic performance and NV performance of the vehicle including the surrounding information detection section on the roof to be improved.

The vehicle flow-regulating structure according to the second aspect of the present invention obtains an excellent advantageous effect of enabling the aerodynamic performance and NV performance of the vehicle to be improved by the roof visor.

The vehicle flow-regulating structure according to the third aspect of the present invention obtains an excellent advantageous effect of enabling the roof visor to be commonly used in vehicles that have a different configuration or placement of the surrounding information detection section.

The vehicle flow-regulating structure according to the fourth aspect of the present invention obtains excellent advantageous effects of enabling the air resistance to be reduced, and the appearance of the vehicle to be improved.

The vehicle flow-regulating structure according to the fifth aspect of the present invention obtains an excellent advantageous effect of enabling the appearance of the vehicle to be improved.

### BRIEF DESCRIPTION OF THE DRAWINGS

FIG. 1 is a perspective view illustrating a vehicle including a vehicle flow-regulating structure according to a first exemplary embodiment;

FIG. 2 is a side view illustrating an airflow regulating operation by a vehicle flow-regulating structure according to the first exemplary embodiment;

FIG. 3 is a perspective view illustrating an example in which a roof visor is disposed in a vicinity of the vehicle front side of a surrounding information detection section;

FIG. 4 is an enlarged cross-section illustrating a wire harness housed inside a inverted-Mohican-shaped section of a roof;

FIG. 5 is a perspective view illustrating a vehicle in which a vehicle flow-regulating structure according to a second exemplary embodiment is provided at a roof rail; and

FIG. 6 is an enlarged cross-section taken along arrows 6-6 in FIG. 5, illustrating an internal structure of a front end portion of the roof rail.

### DETAILED DESCRIPTION OF PREFERRED EMBODIMENTS

Explanation follows regarding exemplary embodiments of the present invention, based on the drawings.

### First Exemplary Embodiment

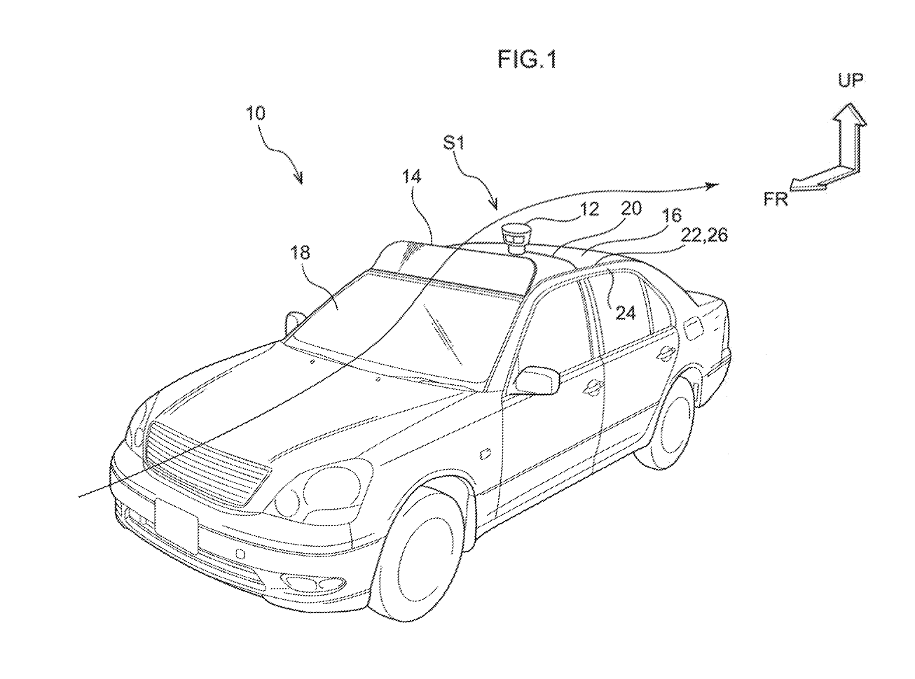

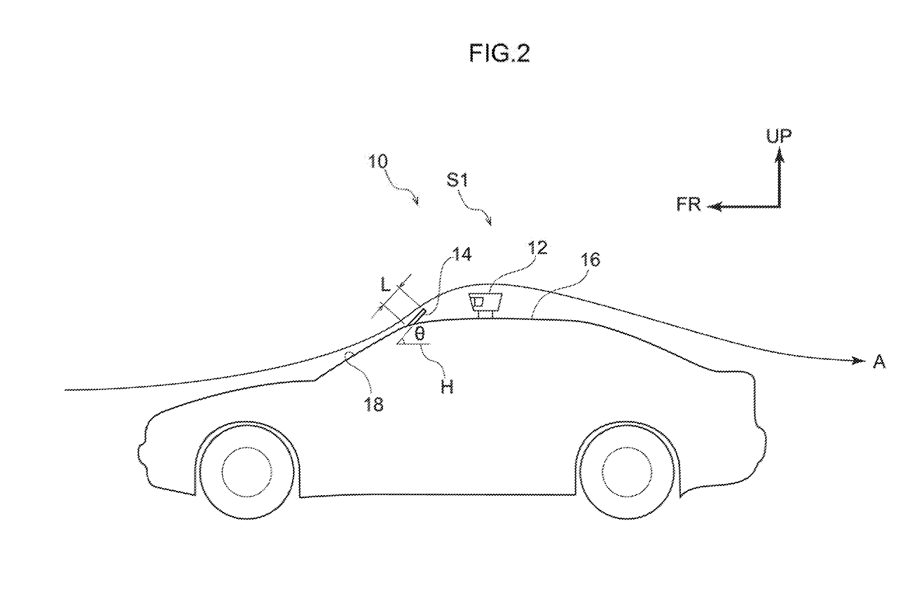

In FIG. 1 and FIG. 2, a vehicle flow-regulating structure S1 according to an exemplary embodiment is employed in an autonomous vehicle 10, for example, and includes a surrounding information detection section 12, and a roof visor 14 that is an example of a flow-regulating means.

The surrounding information detection section 12 is millimeter-wave radar, microwave radar, laser radar, an infrared sensor, an ultrasonic sensor, an optical camera, or the like, which is provided on a roof 16 of the vehicle 10, and detects surrounding information of the vehicle 10. The surrounding information detection section 12 is provided at a center portion of the roof 16, for example, and detects surrounding information of the vehicle 10 while rotating 360 degrees with its rotation axis along the vehicle up-down direction.

Although not illustrated in the drawings, the vehicle 10 is provided with a travel planning section and a travel control section. The travel planning section generates a travel plan along a pre-set target route based on map information, and surrounding information of the vehicle 10 detected by the surrounding information detection section 12. The travel control section automatically controls travel of the vehicle 10 based on the travel plan generated by the travel planning section.

The roof visor 14 is provided on the roof 16, and is a substantially rectangular shaped flow-regulating panel that regulates an airflow A at the surrounding information detection section 12 while the vehicle is travelling. The roof visor 14 is provided at the vehicle front side of the surrounding information detection section 12, for example, and extends diagonally upward toward the vehicle rear side. As an example, the roof visor 14 is provided running along the vehicle width direction across an entire front end of the roof 16. Left and right corner portions of an upper end of the roof visor 14 are rounded into a circular arc shape. It is preferable that the roof visor 14 runs along the slope or curve of a front windshield 18. Note that there is no need for the surrounding information detection section 12 to be covered from the vehicle front side by the roof visor 14, and it is sufficient that the roof visor 14 acts as a trigger to control the airflow A.

In FIG. 2, it is preferable a length L from a lower end as far as the upper end of the roof visor 14, and an angle θ of the roof visor 14 with respect to a horizontal direction H, are set such that the roof visor 14 does not impair detection by the surrounding information detection section 12. In cases in which the roof visor 14 is bent or curved in vehicle side view, the angle θ is an angle (an acute angle, for example) formed by a line segment linking the upper end and lower end of the roof visor 14, and the horizontal direction H in vehicle side view.

Note that at least one of the length L of the roof visor 14, or the angle θ of the roof visor 14 with respect to the horizontal direction, may be variable. Specifically, configuration may be such that only the length L of the roof visor 14 is variable, or only the angle θ of the roof visor 14 is variable. The roof visor 14 may configured so as to extend and retract in order to make the length L variable. A rotation pivot point (not illustrated in the drawings) may be provided at a lower end portion of the roof visor 14 in order to make the angle θ variable.

Moreover, both the length L and angle θ of the roof visor 14 may be variable. In such cases, configuration may be such that the rotation pivot point (not illustrated in the drawings) is provided at the lower end portion of the roof visor 14, and the roof visor 14 extends and retracts at a location above the rotation pivot point, or such that the rotation pivot point is provided partway along the roof visor 14 that extends and retracts. In cases in which a type of surrounding information detection section 12 is employed that is not influenced by the roof visor 14 when detecting surrounding information, the surrounding information detection section 12 may be hidden at the vehicle rear of the roof visor 14.

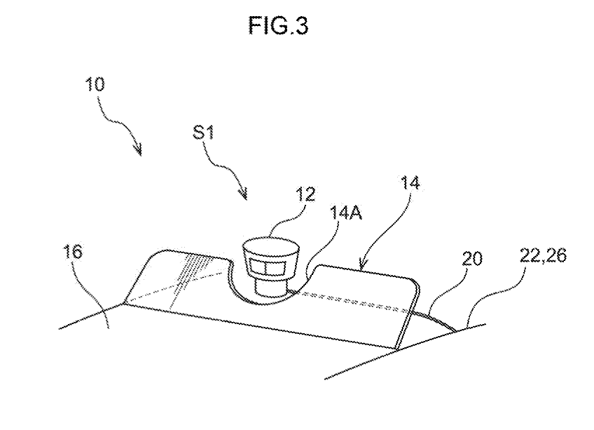

The roof visor 14 may be provided in a vicinity of the vehicle front side of the surrounding information detection section 12. The “vicinity of the vehicle front” includes the following two examples. In the first example, as illustrated in FIG. 3, the lower end of the roof visor 14 is positioned further to the vehicle front than the surrounding information detection section 12, and an upper portion of the roof visor 14 is disposed so as to overlap part of the surrounding information detection section 12 in vehicle side view. In this example a circular arc shaped cutout 14A is provided at the roof visor 14, for example, so as not to impair detection by the surrounding information detection section 12. In the second example, the roof visor 14 is disposed in close proximity to the vehicle front side of the surrounding information detection section 12, to a degree that does not overlap the surrounding information detection section 12 in vehicle side view.

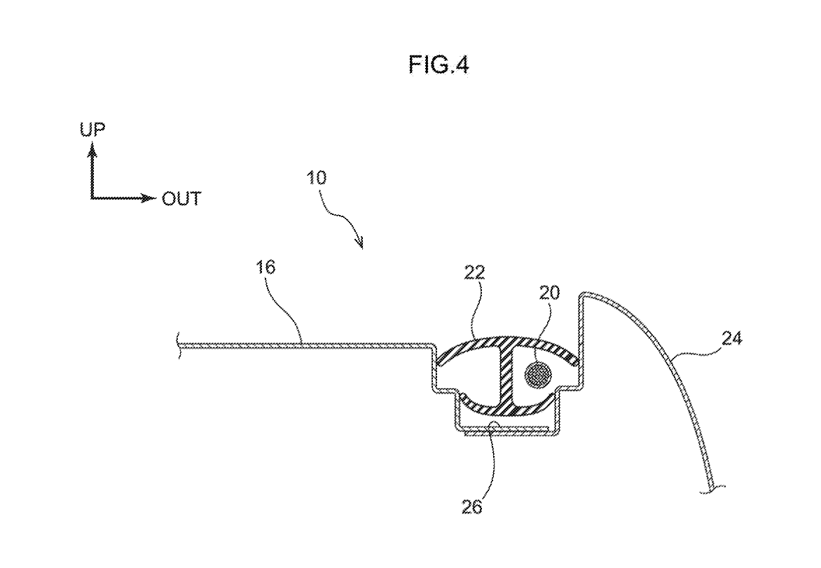

In FIG. 1 and FIG. 4, a wire harness 20 extending from the surrounding information detection section 12 is passed through a mold 22 serving as an example of a wire harness passage section provided at the roof 16. A roof side rail 24 is provided extending along the vehicle front-rear direction at either end portion of the roof 16. An inverted-Mohican-shaped section 26 is provided as an indentation extending along the vehicle front-rear direction at a boundary portion between each roof side rail 24 and the roof 16. The mold 22 is a resin member or a rubber member with an H-shaped cross-section, for example, and is attached so as to cover the inverted-Mohican-shaped section 26. As illustrated in FIG. 1, the wire harness 20 extends from the surrounding information detection section 12 along an upper face of the roof 16 toward the vehicle width direction outside, for example, and is routed inside the mold 22 of the inverted-Mohican-shaped section 26. Although not illustrated in the drawings, the wire harness 20 extends inside the mold 22 in the front-rear direction, is then routed inside the vehicle 10 from a specific position, and connected to the above-described travel planning section.

Operation

Explanation follows regarding operation of the present exemplary embodiment configured as described above. In the vehicle flow-regulating structure S1 according to the present exemplary embodiment in FIG. 1 and FIG. 2, while the vehicle is travelling, the airflow A at the surrounding information detection section 12 provided on the roof 16 is regulated by the roof visor 14 provided on the roof 16. The roof visor 14 is positioned at the front end of the roof 16, and runs along the slope of the front windshield 18. Thus turbulence is less liable to occur in the airflow A from the front windshield 18 to the roof visor 14 while the vehicle is travelling, and the airflow A is led to the vehicle upper side of the surrounding information detection section 12. The airflow A is therefore less liable to hit the surrounding information detection section 12, such that air resistance and noise while the vehicle is travelling is reduced. This enables the aerodynamic performance and NV performance of the vehicle 10 including the surrounding information detection section 12 on the roof 16 to be improved.

Part of the wire harness 20 extending from the surrounding information detection section 12 is passed through and is hidden inside the mold 22 of the inverted-Mohican-shaped section 26. This suppresses the wire harness 20 from being exposed on the roof 16, compared to cases in which the wire harness 20 is not passed through inside the mold 22. Viewed from the vehicle front side, the wire harness 20 on the roof 16 is hidden by the roof visor 14. This enables the appearance of the vehicle 10 to be improved.

Furthermore, suitably setting the length L and the angle θ of the roof visor 14 (FIG. 2) enables surrounding information of the vehicle 10 to be detected by the surrounding information detection section 12 without being influenced by the roof visor 14.

As illustrated in FIG. 3, cases in which at least one of the length L or the angle θ of the roof visor 14 with respect to the horizontal direction is variable enable the airflow A to be controlled according to the configuration and placement of the surrounding information detection section 12, by changing the length L or the angle θ. Moreover, the roof visor 14 can be commonly used in vehicles 10 that have a different configuration or placement of the surrounding information detection section 12.

### Second Exemplary Embodiment

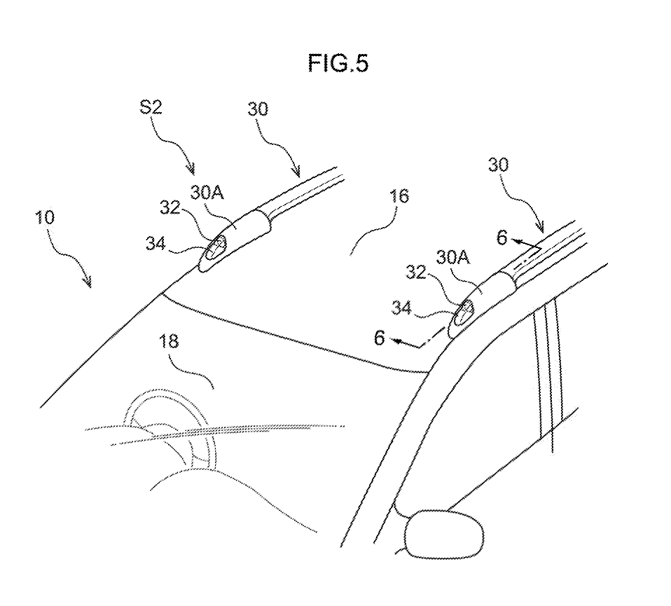

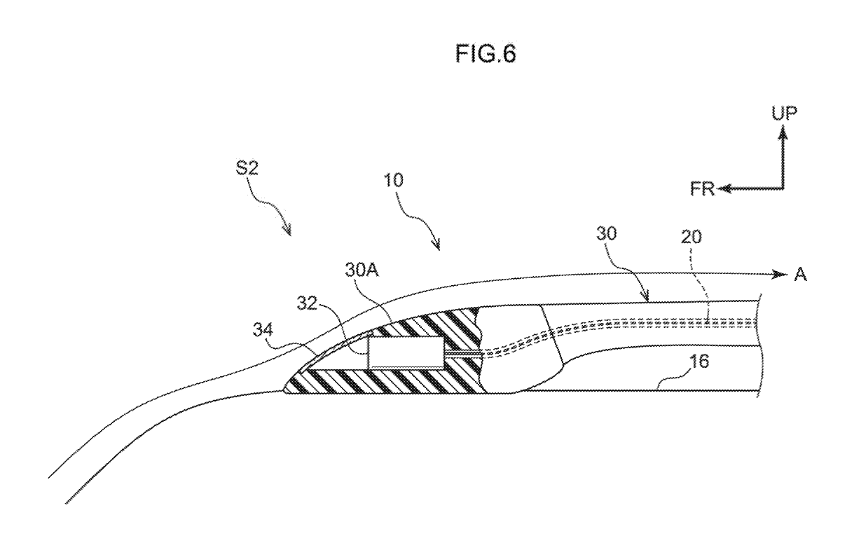

In a vehicle flow-regulating structure S2 according to an exemplary embodiment in FIG. 5 and FIG. 6, surrounding information detection sections 32 that are at least part of a surrounding information detection section are respectively incorporated in front end portions 30A of roof rails 30. Each front end portion 30A is an example of a flow-regulating means, and is formed in a streamlined shape, for example. A pair of the roof rails 30 are provided on the roof 16 of the vehicle 10 at the left and right thereof, and extend along the vehicle front-rear direction.

Each surrounding information detection section 32 is a sensor such as a camera, and is provided inside a cover 34 at the front end portion 30A of the roof rail 30. The cover 34 is formed in a streamlined shape so as to be integral to the front end portion 30A of the roof rail 30. In cases in which the surrounding information detection section 32 is an optical sensor, the cover 34 is configured to be transparent. In cases in which the surrounding information detection section 32 is a radio wave type, it is sufficient that the cover 34 is permeated by radio waves, and so may be opaque.

Note that a surrounding information detection section (not illustrated in the drawings) other than the surrounding information detection sections 32 may be incorporated in the roof rails 30. Moreover, all the surrounding information detection sections may be incorporated in the roof rails 30.

The wire harness 20 extending from each surrounding information detection section 32 passes through inside the roof rail 30, and is then routed inside the vehicle 10 from a specific position, similarly to in the first exemplary embodiment. Namely, the roof rail 30 serves as both a flow-regulating means and a wire harness passage section.

Note that the wire harness 20 may be passed through the mold 22 of the inverted-Mohican-shaped section 26 similarly to in the first exemplary embodiment (see FIG. 4) rather than the roof rail 30.

Other portions are similar to those in the first exemplary embodiment, and so similar portions are appended with the same reference numerals in the drawings, and explanation thereof is omitted.

Operation

Explanation follows regarding operation of the present exemplary embodiment configured as described above. In the vehicle flow-regulating structure S2 according to the present exemplary embodiment in FIG. 5 and FIG. 6, at least part of each surrounding information detection section 32 is incorporated into the front end portion 30A of the roof rail 30. Thus, in cases in which plural types of surrounding information detection section, including the surrounding information detection sections 32, are disposed on the roof 16, there are fewer surrounding information detection sections exposed on the roof 16. This enables the airflow resistance while the vehicle is travelling to be reduced, and the appearance of the vehicle 10 to be improved.

### Other Exemplary Embodiments

Examples of exemplary embodiments of the present invention have been explained above; however, exemplary embodiments of the present invention are not limited to those described above, and obviously various other modifications may be implemented within a range not departing from the spirit of the present invention.

In the first exemplary embodiment, the wire harness 20 extending from the surrounding information detection section 12 passes through inside the mold 22 of the inverted-Mohican-shaped section 26; however, configuration may be made such that the wire harness 20 does not pass through the mold 22, and the wire harness 20 is exposed as far as a portion routed inside the vehicle 10. Moreover, the mold 22 of the inverted-Mohican-shaped section 26 (first exemplary embodiment) and the roof rail 30 (second exemplary embodiment) have been given as examples of a wire harness passage section; however, the wire harness passage section is not limited thereto. For example, it may be a mold that is provided on the upper face of the roof 16.

The above exemplary embodiments may be combined as appropriate. For example, the surrounding information detection section 12 according to the first exemplary embodiment may be combined with the second exemplary embodiment, and the roof visor 14 may also be combined therewith. In such cases, the width of the roof visor 14 may be narrowed such that the roof visor 14 does not block the vehicle front side of the roof rails 30.

What is claimed is:

1. A vehicle flow-regulating structure comprising:
a surrounding information detection section that is provided on a roof of a vehicle and that detects surrounding information of the vehicle; and
a flow-regulating means that is provided on the roof and that regulates airflow at the surrounding information detection section while the vehicle is travelling.

2. The vehicle flow-regulating structure of claim 1, wherein
the flow-regulating means is provided at a vehicle front side of the surrounding information detection section, or in a vicinity of the vehicle front side of the surrounding information detection section, and is a roof visor that extends diagonally upward toward a vehicle rear side.

3. The vehicle flow-regulating structure of claim 2, wherein
at least one of a length of the roof visor, or an angle of the roof visor with respect to a horizontal direction, in a vehicle side view is variable.

4. The vehicle flow-regulating structure of claim 2, wherein
the lower end of the roof visor is positioned further to the vehicle front than the surrounding information detection section, and
an upper portion of the roof visor is disposed so as to overlap part of the surrounding information detection section in vehicle side view.

5. The vehicle flow-regulating structure of claim 2, wherein
the roof visor is disposed in close proximity to the vehicle front side of the surrounding information detection section, to a degree that does not overlap the surrounding information detection section in vehicle side view.

6. The vehicle flow-regulating structure of claim 1, wherein
at least part of the surrounding information detection section is incorporated in the flow-regulating means.

7. The vehicle flow-regulating structure of claim 1, wherein
a wire harness extending from the surrounding information detection section is passed through a wire harness passage section provided at the roof.
